(19) United States
(12) Patent Application Publication
(10) Pub. No.: US 2021/0035106 A1
(43) Pub. Date: Feb. 4, 2021

(54) SIMILARITY MEASUREMENT BETWEEN USERS TO DETECT FRAUD

(71) Applicant: PayPal, Inc., San Jose, CA (US)

(72) Inventors: Nan Lin, Shanghai (CN); Lidong Ge, Shanghai (CN); Ying Lin, Shanghai (CN); Dongxue Li, Shanghai (CN)

(21) Appl. No.: 16/945,451

(22) Filed: Jul. 31, 2020

(30) Foreign Application Priority Data
Jul. 31, 2019 (CN) PCT/CN2019/098585

(51) Int. Cl. G06Q 20/40; G06K 9/62

(52) U.S. Cl. CPC G06Q 20/4016; G06Q 20/4015; G06K 9/6215

(57) ABSTRACT

Techniques are disclosed relating to determining validity of a flagged transaction in a transaction service. A server computer system may receive an indication of a flagged transaction between a sending user and a receiving user of a transaction service. The server computer system may collect, responsive to the indication, transaction information including sender information and receiver information, and then determine a similarity value indicative of an amount of similarity between the sender information and the receiver information. The server computer system may assess, based on the similarity value, whether the flagged transaction is valid.

### PRIORITY CLAIM

The present application claims priority to PCT Appl. No. PCT/CN2019/098585, filed Jul. 31, 2019, which is incorporated by reference herein in its entirety.

### BACKGROUND

### Technical Field

This disclosure relates generally to server computer security, and more particularly to detecting fraud involving entities that are using an online service.

### Description of the Related Art

Server computer systems, such as web servers, application servers, email servers, etc., provide various computing resources and services to multiple end users, businesses, government agencies, and the like (collectively referred to herein as entities). For example, a web service may use a computer system to enable a transaction between two or more entities, the transaction including, for example, information, goods, services, and the like. The web service may provide some form of assurance that the transaction is carried out in good faith by each of the two or more parties. Failure of one entity to complete their portion of a transaction may allow for another entity who completed their portion of the transaction to receive compensation. Such compensation for a failed transaction may include free or discounted use of the web service, financial reimbursement, access to additional services, and other forms of compensation. Assurances provided by the web service provider may be beneficial for attracting customers to their provided services, but it can also be used by malicious third-parties to attempt fraudulent activity against the web service with the goal of receiving undeserved compensation.

One form of fraudulent activity may include two or more entities working together to create a fraudulent transaction that appears to be a failed transaction. A sending entity may file a claim for compensation on the fraudulent transaction, and then share any form of compensation with a receiving entity. Determining that a failed transaction is actually a fraudulent transaction is difficult and may result in a false denial of compensation for a legitimate failed transaction.

### BRIEF DESCRIPTION OF THE DRAWINGS

FIG. 1 illustrates a block diagram of an embodiment of a system for determining a fraud risk in response to an indication of a flagged transaction between a sending user and a receiving user.

FIG. 2 shows two tables information associated with the sending user and information associated with the receiving user of the flagged transaction, according to some embodiments.

FIG. 3 depicts direct links between the sending user and the receiving user of the flagged transaction, according to some embodiments.

FIG. 4 illustrates intermediate links between the sending user and the receiving user involving a common user, according to some embodiments.

FIG. 5 shows intermediate links between the sending user and the receiving user involving two counterparties, according to some embodiments.

FIG. 6 depicts various types of direct links between the sending user and the receiving user of the flagged transaction, according to some embodiments.

FIG. 7 illustrates a flow diagram of an embodiment of a method for determining a fraud risk in response to an indication of a flagged transaction between a sending user and a receiving user.

FIG. 8 illustrates a flow diagram of an embodiment of a method for determining a fraud probability value using a number of links identified between a sending user and a receiving user.

FIG. 9 is a block diagram illustrating an example computer system, according to some embodiments.

### DETAILED DESCRIPTION

In an attempt to defraud an operator of an online service, two or more users may collude (i.e., work together) to initiate a transaction that appears to be a failed transaction that is eligible for compensation from the operator. Similarly, a single entity may control two or more accounts of the online service, and coordinate those accounts in a manner that attempts to defraud the service. Both scenarios are forms of fraud.

When a claim for compensation is initiated, the operator of the online service may determine if the sending and receiving users of a transaction are in fact linked with one another. This may indicate either collusion between two parties, or that the sending and receiving user are controlled by a single party—both of which constitute a fraudulent transaction. By accurately detecting such transactions and declining the corresponding claims, the operator can avoid an unnecessary loss from fraudulent compensation. For example, a typical fraudulent transaction may involve a sending user A sending an item (e.g., data/money/goods) to a receiving user B using a web service provided by an operator, with user B then taking delivery of the transferred item. User A files a claim for compensation to the operator, claiming that user B did not fulfill their portion of the transaction. Failing to detect signs of collusion, the operator may provide an agreed upon compensation to user A, which user A then shares with user B. Since user B has taken delivery of the transferred item, the operator is not able to recoup any losses from user B. The operator may place a negative balance on user B's account, or may cancel user B's account, neither of which helps the operator to recover the lost compensation to user A. Again, note that A and B may actually be controlled by a single entity, with the same fraudulent result. In another example, sending user A again sends the item to receiving user B. User A may then file a claim, stating that user B never received the item. Without detecting signs of collusion, the operator may provide compensation to user A, which may then be shared with user B. As with the previous example, users A and B may be controlled by a single entity.

Systems and methods are desired to collect information about users involved in a failed transaction for which a compensation claim has been made, and then use this information to make a determination if the compensation claim is valid or fraudulent. Such systems and methods are disclosed herein that may provide an increased ability for detecting fraudulent activity associated with a transaction that results in a compensation claim. One such method may include, in response to an indication of a transaction flagged as failed, collecting, by a server computer system, transaction information for a sending user and a receiving user, including transaction information regarding transactions that the sending user and receiving user have had with users other than each other. The server computer system may then determine a similarity value indicative of an amount of similarity between the sender's information and the receiver's information. Using the similarity value, the server computer system may assess whether the flagged transaction is valid or not. If the flagged transaction is determined to be fraudulent, then the operator may refuse to compensate the sending user for the flagged transaction.

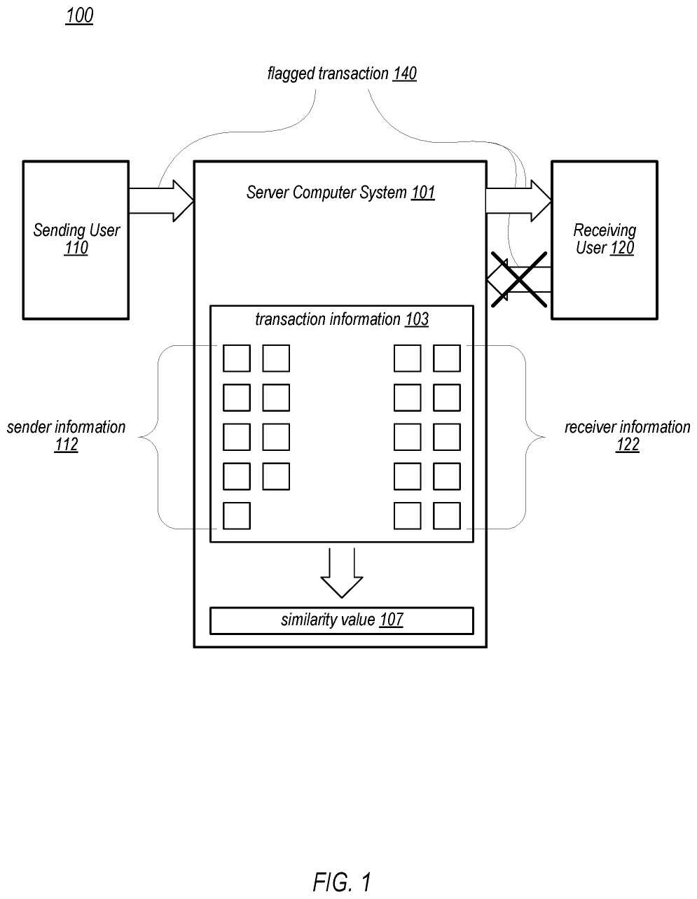

An embodiment of a server computer system and two users of the server computer system is shown in FIG. 1. System 100 includes sending user 110 who initiates flagged transaction 140 with receiving user 120. Flagged transaction 140 is performed by server computer system 101. Server computer system 101 includes transaction information 103, which, in turn, includes sender information 112 and receiver information 122. Server computer system 101 uses transaction information 103 to determine similarity value 107.

As illustrated, sending user 110 initiates a transaction with receiving user 120 using an online transaction service that is hosted, at least in part, by server computer system 101. The transaction may include an exchange of, for example, goods, data, media, money, or any combination thereof. In various embodiments, sending user 110 and receiving user 120 may each correspond to any type of entity, such as individuals, organizations, companies, and the like. Sending user 110 fulfills their portion of the transaction while, in contrast, receiving user 120 does not fulfill their portion. Sending user 110, in response, flags the transaction, thereby creating flagged transaction 140.

Server computer system 101 receives an indication that sending user 110 has created flagged transaction 140. In response to receiving the indication, server computer system 101 collects data from transaction information 103. Transaction information 103 may include any suitable data associated with transactions that have previously been processed by server computer system 101, as well as current information related to user accounts for sending user 110 and receiving user 120, for example, contact information and financial information. In various embodiments, server computer system 101 may store, as transaction information 103, records of previous transactions dating back for any suitable period of time, such as six months, one or more years, or since the online transaction service was established.

Server computer system 101, as shown, retrieves sender information 112 and receiver information 122 from transaction information 103. Sender information 112 includes information indicative of previous transactions within the online transaction service involving sending user 110, including transactions conducted with users other than receiving user 120. Similarly, receiver information 122 includes information indicative of previous transactions within the online transaction service involving receiving user 120, including transactions conducted with users other than sending user 110. Sender information 112 and receiver information 122 may include various types of data, such as values identifying computers or other computing devices used when accessing server computer system 101, contact information, financial information, dates and times associated with previous transactions, indications of other users involved in the previous transactions, and the like.

Server computer system 101 determines similarity value 107 using sender information 112 and receiver information 122. As its name suggests, similarity value 107 is indicative of an amount of similarity between sender information 112 and receiver information 122, as measured by “linkages” between these sets of information. Such linkage between sending user 110 and receiving user 120 may include direct links with each other (e.g., the two user have transacted together), as well as indirect links. Examples of indirect links include transactions with common users (e.g., both the sending user 110 and receiving user 120 have each transacted with another particular user), and transactions between counterparties associated with sending user 110 and receiving user 120 (e.g., an entity that sending user 110 has interacted with has in turn interacted with an entity that has interacted with receiving user 120). As used herein, a “counterparty” of a particular user refers, within the context of a transaction service, to another user that the particular user has interacted with via the service. A set of “counterparties” for a particular user of a service thus refers to one or more (or all) of the other users with which the particular user has interacted with via the service.

In addition, links between the sending user 110 and receiving user 120 may also include similarities in other types of information. Such information may include, for example, similarities between devices and networks used to access the online transaction service, between contact information listed in respective accounts, and between various types of financial account information listed in respective accounts. In some embodiments, similarity value 107 may provide an indication of a number of transactions that sending user 110 and receiving user 120 have been involved in that have various links to one another. For example, links between sending user 110 and receiving user 120 may include information that is common directly between sending user 110 and receiving user 120, and information that is common with a third-party user who has been involved with transactions between both sending user 110 and receiving user 120. In addition, server computer system 101 may identify links between a first counterparty associated with the sending user and a second counterparty that is associated with receiving user 120.

Based on the similarity value, server computer system 101 assesses whether flagged transaction 140 is valid. In various embodiments, similarity value 107 may equal a number of detected links between sending user 110 and receiving user 120, or may be a value within a predefined range that is determined based on the number of detected links, such as a ratio of detected links to a total possible number of links based on the previous transactions. Server computer system 101 may compare similarity value 107 to one or more threshold values as part of the assessment. In one example, similarity value 107 may be a value calculated based on the detected links and falling between a minimum and maximum value. Server computer system 101 compares similarity value 107 to a single threshold value and determines that flagged transaction 140 is fraudulent if similarity value 107 reaches the single threshold value. In another example, similarity value 107 may equal a total number of detected links. Server computer system 101 may compare similarity value 107 to multiple threshold values, each indicative of a particular likelihood that flagged transaction 140 is fraudulent. Based on the likelihood of a fraudulent transaction, additional actions may be taken. Threshold values (both single and multiple) may be determined based on an analysis of previously flagged transactions. As more flagged transactions are processed, one or more threshold values may be adjusted to improve the accuracy of the fraud determinations.

It is noted that the embodiment of FIG. 1 is merely an example. Only features related to the description of the embodiment are shown. Other embodiments may include additional features. As shown, sender information 112 and receiver information 122 are illustrated as ten or fewer boxes, each box representing information related to a particular transaction. In other embodiments, any suitable number of transactions may be included in the historical information, such as hundreds, thousands, or more.

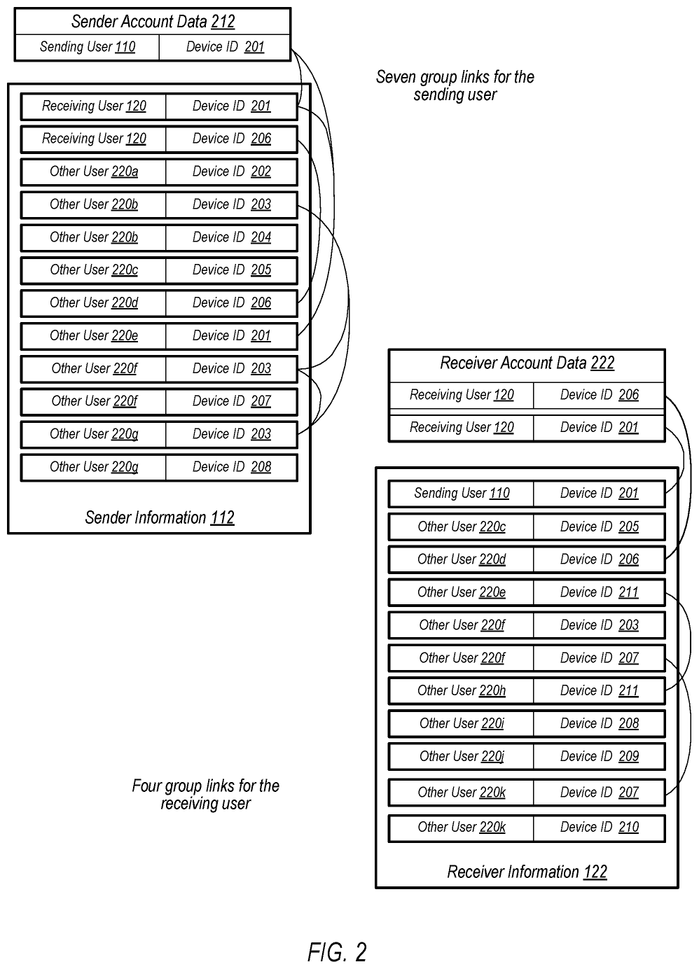

In the description of FIG. 1, collection of information associated with the sending and receiving users is discussed. As described, this information is used to identify links between the sending and receiving users. Additional details regarding the collected information are disclosed below in regards to FIG. 2.

Moving to FIG. 2, examples of sender information and receiver information are depicted. Server computer system 101 retrieves sender information 112 and receiver information 122 in order to determine similarity value 107. Sender information 112 and receiver information 122 include respective lists of other users 220a-220k (collectively referred to as other users 220) with which each of sending user 110 and receiving user 120 have participated in transactions using the online transaction service hosted by server computer system 101 of FIG. 1. In addition, device identification values (device IDs) 201-211 are collected for each user identified in sender information 112 and receiver information 122. The retrieved sender information 112 is compared with sender account data 212, and the retrieve receiver information 122 is compared to receiver account data 222.

Sender account data 212 includes information regarding account data for sending user 110, including any device IDs associated with computing devices that sending user 110 has used to access the online transaction service. In this case, device ID 201 has been identified with sending user 110. Similarly, receiver account data 222 includes information associated with the account of receiving user 120. In this case, device IDs 206 and 201 have been associated with receiving user 120.

As shown, sender information 112 indicates that sending user 110 has had previous transactions with other users 220a-220g, as well as a prior transaction (not including flagged transaction 140) with receiving user 120. Receiver information 122 similarly indicates that receiving user 120 had previous transactions with other users 220c-220f, and 220h-220k. Any suitable information associated with the online transaction service may be used to identify each user, such as a respective account number, username, full legal name, email address, and the like.

As illustrated, an additional piece of information is collected for each identified user, a device ID that identifies a computing device (e.g., a personal computer, smart phone, laptop computer, table computer, and the like) that the corresponding user has used to access the online transaction service. In various embodiments, the device ID may correspond to a device associated specifically with the identified transaction with sending user 110 or receiving user 120, or may include all devices with which the corresponding user has accessed the online transaction service. Device IDs 201-211 may include any suitable identifying value associated with the respective device. For example, device IDs 201-211 may be a media access control (MAC) address, or other hardware identification value associated with a particular computing device. In some embodiments, device ID may include a value that is included in a cookie (e.g., a packet of data stored on the respective device) that the online transaction service has stored on the corresponding device.

It is noted that sender information 112 includes two entries for several users: other users 220b, 220f, and 220g. Similarly, receiver information 122 includes two entries for other users 220f and 220k. In the illustrated embodiment, a separate entry is included for each device ID that the user has used when accessing the online transaction service. In other embodiments, separate entries for a given user may be included for each transaction the given user has had with the sending user 110 or receiving user 120.

It is further noted that to retrieve sender information 112 and receiver information 122, server computer system 101 may retrieve transactions that occurred within a particular range of dates. For example, server computer system 101 may retrieve information regarding transactions with which sending user 110 and receiving user 120 have been associated within two years of a current date, or within a year of the date of flagged transaction 140. In other embodiments, server computer system 101 may retrieve all available information regarding any transaction with which sending user 110 and receiving user 120 have been associated.

The users identified in sender information 112 may collectively be referred to herein as the “sender's group” or “sender group” and the users identified in receiver information 122 may collectively be referred to herein as the “receiver's group” or “receiver group.” As shown, server computer system 101 retrieves the sender's group and the receiver's group to determine similarity value 107. Similarity value 107 is used to indicate a probability or likelihood of fraud. Accordingly, within the current disclosure, a fraud probability value is a value used to determine whether a flagged transaction is a fraudulent transaction initiated with no intent to complete a transaction, but instead to receive compensation from the operator of the online transaction service. In some cases, a determination of fraud may be made by comparing the fraud probability value to a specified threshold, which may in some cases change over time.

To generate the fraud probability value, server computer system 101 may identify links between two or more counterparties of sending user 110, and identify links between two or more counterparties of receiving user 120. A “link” between two users refers to some indicia of similarity or connectedness. For example, a link may be based on similar user profile information, similar transaction history, particularly transaction history that indicates the two users have directly engaged in transactions, or have indirect connections via other users of the service. Referring to sender information 112, as shown, sending user 110 has participated in transactions with each user in the sender's group. Server computer system 101 may identify additional links, referred to as “group links,” between the users of the sender's group. As illustrated, sending user 110 has used a device with device ID 201. Receiving user 120 and other user 220e have also used a device with device ID 201. Server computer system 101 identifies these common uses of device ID 201 as three group links. Four additional group links (for a total of seven) are identified in the sender's group: receiving user 120 and other user 220d have device ID 206 in common, and other user 220b, other user 220f, and other user 220g each have device ID 203 in common.

Server computer system 101 further identifies four group links for the receiver's group. The common use of device ID 201 between sending user 110 and receiving user 120 and the common use of device ID 206 by receiving user 120 and other user 220 may each be counted again for the receiver's group. In addition, other user 220e and other user 220h have device ID 211 in common. Other user 220f and other user 220k have device ID 207 in common.

It is noted that FIG. 2 is merely an example for demonstrating disclosed concepts. Only users and device IDs have been illustrated as collected information used to identify links between the sending user and the receiving user within their respective groups. In other embodiments, additional information may be collected, such as contact information, banking account numbers, and physical location information.

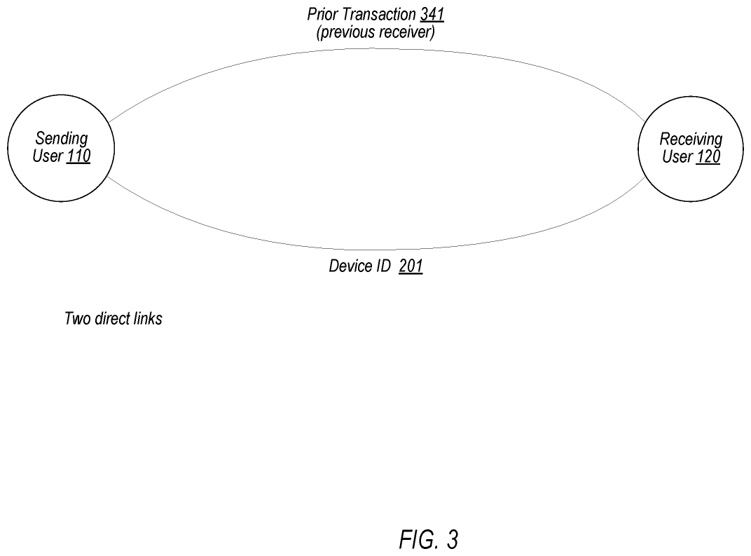

The links identified above may be used to determine a fraud value such as similarity value 107. The illustrated sender information and receiver information collected by the server computer system may be used in several additional ways to identify further links between the sending and receiving users. These further links may also be used with the links above to determine the fraud value. Several exemplary ways are illustrated in FIGS. 3, 4, and 5, as described below.

Turning to FIG. 3, an embodiment depicting direct links between a sending user and a receiving user are shown. FIG. 3 illustrates two links that server computer system 101 may detect between sending user 110 and receiving user 120, based on sender information 112 and receiver information 122 of FIG. 2. These two links are referred to as “direct links” as no user is involved other than sending user 110 and receiving user 120. The two links are prior transaction 341 and device ID 201.

Prior transaction 341 is a transaction that has occurred directly between sending user 110 and receiving user 120 prior to flagged transaction 140 occurring. In addition to detecting prior transaction 341, server computer system 101 may further retrieve information indicating that receiving user 120 was also the receiving user during prior transaction 341. In some embodiments, determining the “direction” of prior transactions (e.g., identifying which user is the sending user and which user is the receiving user for a particular transaction) may be used to adjust or weight prior transactions when determining similarity value 107. For example, if sending user 110 is the sending user for prior transaction 341 and receiving user 120 is the receiving user for both transactions 140 and 341, this consistency in the sender receiver relationship may be indicative of a possible vendor/customer relationship, and therefore may reduce a probability that flagged transaction 140 is fraudulent. In contrast, cases in which the sending user and the receiving user change roles over multiple transactions may be indicative of fraudulent behavior. Of course, the mere fact of consistency in the sender/receiver relationship does not always indicate that a transaction is valid; many such transactions may be flagged as fraudulent based on a combination of factors, some of which may be weighted more than others.

In addition to prior transaction 341, server computer system 101 may detect that both sending user 110 and receiving user 120 have used a computing device with a common device ID 201. Since a device ID is used to indicate a specific computing device, having a common device ID for both users participating in a transaction should be an uncommon occurrence, and therefore increases a possibility that flagged transaction 140 is fraudulent. While it may be possible that, for example, sending user 110 obtained the device with device ID 201 from receiving user 120 in a previous transaction, use of a same computing device by sending user 110 and receiving user 120 is typically a rare occurrence in valid transactions, and therefore may be identified as a direct link between sending user 110 and receiving user 120.

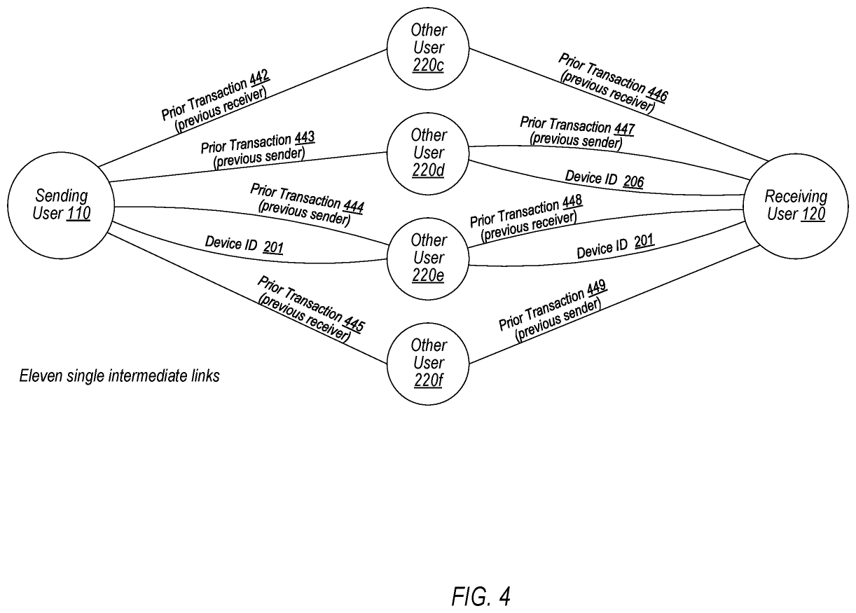

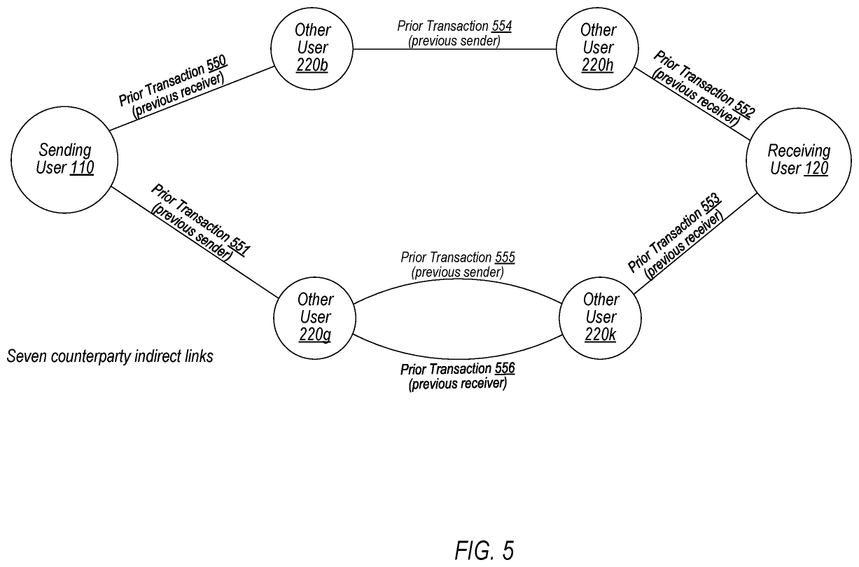

FIG. 3 illustrates examples of direct links between a sending user and a receiving user. For users attempting to collude to defraud an operator of an online transaction service, direct links may be easy to avoid, and therefor uncommon to encounter. A server computer system attempting to determine fraudulent activity, therefore, may look for additional links that may be more difficult for colluding users to avoid. FIGS. 4 and 5 depict examples of indirect links that may be identified. In contrast to direct links, indirect links between a pair of users are established by information associated with other users.

Proceeding to FIG. 4, an embodiment shows examples of indirect links that indicate that sending user 110 and receiving user 120 each have a link with a common other user. As illustrated, server computer system 101, using sender information 112 and receiver information 122, determines that sending user 110 and receiving user 120 have links to four common intermediate users: other users 220c-220f. Eight prior transactions (442-449) are identified along with three common uses of computing devices, resulting in eleven total indirect links between sending user 110 and receiving user 120 involving a single common other user per link.

Device ID 201, as shown, is linked to sending user 110, receiving user 120, and other user 220e. In addition, device ID 206 is linked to receiving user 120 and other user 220d. As described above, use of a common computing device may be an unexpected occurrence between different users of the online transaction service, and therefore, may suggest that users of a common computing device are acquainted with one another. A failed transaction between acquainted users may be used as an indication that the failed transaction may be fraudulent.

Server computer system 101 determines that sending user 110 has been involved in prior transactions 442-445 with other users 220c-220f, respectively. In addition, server computer system 101 determines that receiving user 120 has been involved in prior transactions 446-449 with other users 220c-220f, respectively. As described above, the direction of each of transactions 442-449 is determined and may be used to further determine if a pattern exists between particular pairs of users that might indicate a particular type of connection, such as the previously mentioned customer-vendor relationship that may be indicative of valid transactions. In a customer-vendor relationship, a customer may typically be the sending user and a vendor may typically be the receiving user. In contrast, a determination that one or more users' roles frequently change may provide an indication that a group of users, or one or more users utilizing multiple accounts and computing devices, are generating fraudulent transactions.

This set of eleven indirect links involving common other users may be combined, by server computer system 101, with the set of two direct links shown in FIG. 3, and used to determine similarity value 107. In a similar manner as described above in regards to FIG. 3, a value associated with each link may be weighted based on the types of prior transactions and the roles the participating users had in the corresponding transaction.

FIG. 4 depicts one type of indirect link, involving one common user in between the sending user and the receiving user. A group of users attempting fraudulent activity, however, may be knowledgeable to avoid both direct links and indirect links with a common intermediate user. FIG. 5 demonstrates another form of indirect link in which a link is detected between a user in the sender's group and a different user in the receiver's group.

Moving now to FIG. 5, an embodiment shows examples of indirect links that indicate that a first counterparty of sending user 110 has a link with a second counterparty of receiving user 120. As illustrated, server computer system 101, again using sender information 112 and receiver information 122, determines that two particular counterparties in the sender's group (other users 220b and 220g) have respective links to two different counterparties in the receiver's group (other users 220h and 220k).

Server computer system 101 uses sender information 112 to generate a list of users in the sender's group and uses receiver information 122 to generate a list of users in the receiver's group. For each user in the sender's group, server computer system 101 may search for a link to one or more of the users in the receiver's group. This search may detect links for which neither sending user 110 or receiving user 120 are directly involved.

As shown, sending user has had prior transaction 550 with other user 220b. Other user 220b has participated in prior transaction 554 with other user 220h. Other user 220h, in turn, has had prior transaction 552 with receiving user 120. These three prior transactions (550, 554, and 552) indicate linkage between sending user 110 and receiving user 120 despite the fact that neither sending user 110 nor receiving user 120 were involved with prior transaction 554. Furthermore, the three transactions may have occurred independently of one another, occurring on different dates, and having no shared goods, data, media, money, or the like.

Another linkage is determined by server computer system 101 involving other user 220g and other user 220k. In this case, other users 220g and 220k have had two prior transactions (555 and 556). As described above, server computer system 101 may account for various roles each user had in each of the identified transactions, using the directions of the transactions to determine if a pattern exists that may indicate valid transactions or fraudulent activity.

As illustrated, server computer system detects seven counterparty links between sending user 110 and receiving user 120. This set of seven counterparty indirect links may be combined with the set of eleven common user indirect links and the set of two direct links shown in FIGS. 3 and 4. In some embodiments, server computer system 101 may determine a respective similarity value for each set of links, and then generate a combined similarity value 107 from these three values. In other embodiments, all detected links may be used in combination to generate similarity value 107.

In FIGS. 2-5, for clarity, only prior transactions and device IDs are used for determining links. Transaction information 103 in FIG. 1, however, may include various additional types of information for users of the online transaction service. Some examples of the types of additional data that may be utilized when identifying links between a sending user and a receiving user are described below.

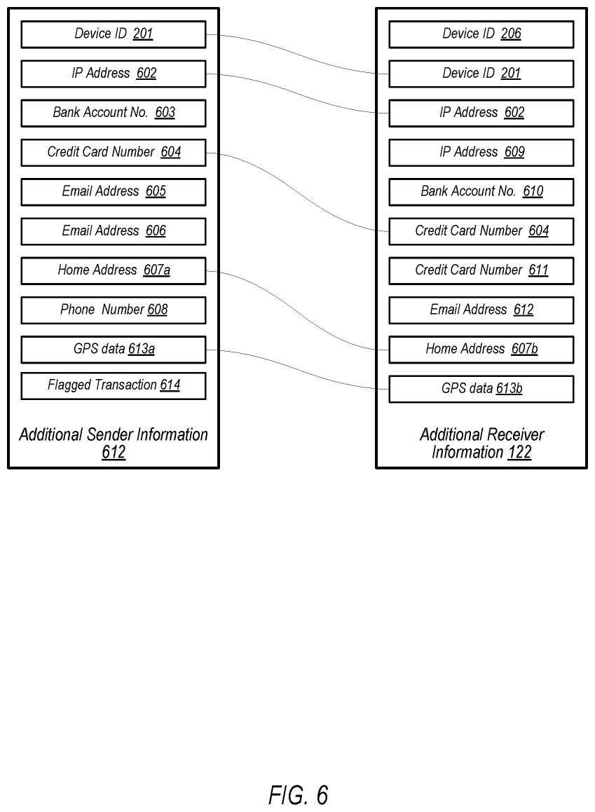

Turning now to FIG. 6, examples of data used to identify links between a sending user and a receiving user are depicted. The information shown in FIG. 6 may be retrieved by server computer system 101 from transaction information 103 and/or additional resources, such as a repository of user account information. Additional sender information 112 includes device ID 201, internet protocol (IP) address 602, bank account number 603, credit card number 604, email addresses 605 and 606, home address 607a, phone number 608, global positioning system (GPS) data 613a, and flagged transaction 614. Additional receiver information 122 includes device IDs 201 and 206, IP addresses 602 and 609, bank account number 610, credit card numbers 604 and 611, email address 612, home address 607b, and GPS data 613b.

In addition to the prior transactions and device ID information described above, server computer system 101 may utilize additional sender information 112 and additional receiver information 122 to identify links between sending user 110 and receiving user 120. For example, identified links may include contact information for each of sending user 110 and receiving user 120. Contact information may include any information that a user provides to the online transaction service regarding how the user may be contacted. Such contact information may include email addresses, home addresses, and phone numbers. Identified links may also include financial information provided by the user, such as bank account numbers and credit or debit card numbers.

As illustrated, sending user 110 and receiving user 120 have five direct links. As was previously shown in FIG. 3, both sending user 110 and receiving user 120 had used a same computing device as indicated by device ID 201. In addition, sending user 110 and receiving user 120 are linked by a common IP address, indicating use of a same network, and by inclusion of a same credit card number 604 in each of their respective accounts. Another link indicates similarity between home address 607a for sending user 110 and home address 607b for receiving user 120. In this case, home addresses 607a and 607b may not be identical, but instead may indicate a close proximity to each other, such as being on a same street, or in a same zip code or other mailing code. Phone numbers may be used in a similar manner to indicate co-location in a same area code or exchange prefix. GPS data 613a and GPS data 613b may, similarly, not be identical but instead indicate location of sending user 110 and receiving user 120 within a certain range of each other. GPS data, it is noted, may be collected for a user when the user accesses the online transaction service via a smart phone or other device with GPS capabilities. While similar locations for two users may not indicate fraudulent activity, close proximity does allow for a possibility that two users could have met in person to arrange a fraudulent scheme.

In addition to looking for information that is the same or similar, server computer system may determine a number of previously flagged transactions associated with sending user 110 and a number of previously flagged transactions associated with receiving user 120. In the illustrated embodiment, sending user 110 has one previously flagged transaction and receiving user 120 has zero. Accordingly, no link may be established for this particular data point.

Some of the illustrated additional information includes data that a user may add or update when logged into an account. For example, financial and contact information may be updated or added by a user at any given time. The online transaction service may track when and how often a user makes changes to their respective information. When determining similarity value 107, server computing system 101 may include determining an amount of data added or changed by sending user 110 and an amount of data added or changed by receiving user 120 to their respective accounts on the online transaction service. In some embodiments, the search for changes may be limited to a specified period of time, for example, within a week or a month of flagged transaction 140.

The information collected for additional sender information 112 and additional receiver information 122, when taken individually, may not be explicitly indicative of fraudulent activity. Server computer system 101, however, analyzes all of the collected information to identify particular patterns or behavior by sending user 110 and/or receiving user 120 that may provide an indication that flagged transaction 140 is a fraudulent transaction.

It is noted that the additional user data shown in FIG. 6 is merely an example. In various embodiments, additional types of data may also be included, such as occupation and a length of time the user has had an account on the online transaction service. Although the additional information is described as being used for identifying direct links between the sending and receiving users, such data may be collected for all user listed in the sender's group and the receiver's group and used to identify indirect links to a common user as well as counterparty indirect links.

FIGS. 1-6 describe a system and information used for determining links between users involved in a flagged transaction. Various methods may be utilized by the disclosed system to identify these links and determine a corresponding fraud probability. Two possible methods associated with determining a fraud probability are now described below.

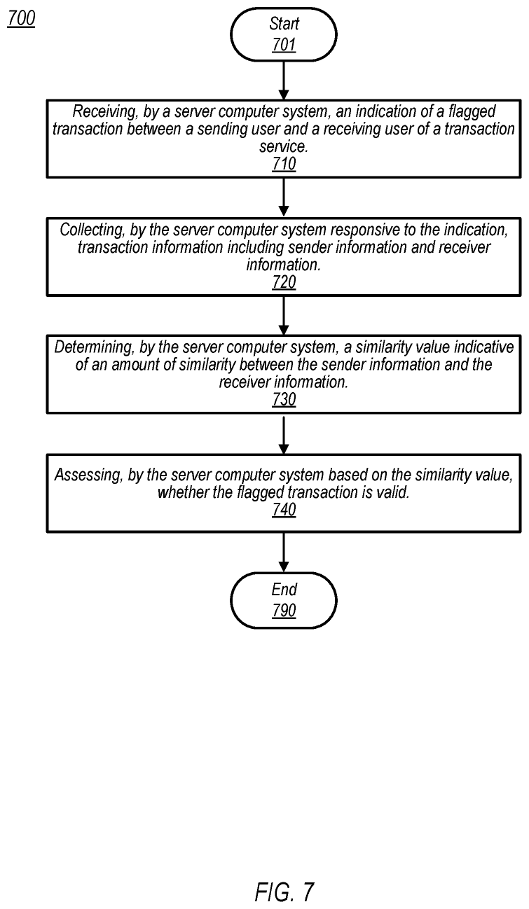

Turning now to FIG. 7, a flow diagram of an embodiment of a method for assessing validity of a flagged transaction is depicted. As illustrated, method 700 may be performed by server computer system 101 of FIG. 1 to determine whether flagged transaction 140, initiated in via a transaction service, is a valid or fraudulent transaction. In some embodiments, server computer system 101 may include (or have access to) a non-transitory, computer-readable medium having program instructions stored thereon that are executable by server computer system 101 to cause the operations described with reference to FIG. 7. Referring collectively to FIGS. 1 and 7, method 700 begins in block 701.

Method 700 includes receiving, by a server computer system, an indication of a flagged transaction between a sending user and a receiving user of a transaction service (block 710). The transaction service, in some embodiments, may be implemented, by server computer system 101. Both sending user 110 and receiving user 120 have user accounts for the transaction service, and sending user 110 initiates a transaction that includes an exchange of items. The items may include, for example, goods, data, media, currency, or any combination thereof. A flagged transaction may indicate that sending user 110 has fulfilled their portion of the transaction but receiving user 120 has not completed their portion. Sending user 110 files a claim for compensation for the sent item in response to not receiving a corresponding item from receiving user 120. In response to eh filing of the claim, the transaction is flagged as flagged transaction 140. Server computer system 101 attempts to determine if flagged transaction is a valid transaction, or if sending user 110 and receiving user 120 are working together in an attempt to defraud the operators of the transaction service.

Additionally, method 700 includes collecting, by the server computer system responsive to the indication, transaction information including sender information and receiver information (block 720). Transaction information 103 includes sender information 112 that is indicative of previous transactions within the transaction service involving sending user 110, including transactions with users other than receiving user 120. Furthermore, transaction information 103 includes receiver information 122 indicative of previous transactions within the transaction service involving receiving user 120, including transactions with users other than the sending user 110.

Sender information 112 and receiver information 122 may include any suitable data stored in, or accessible by, server computer system 101. For example, sender information 112 may include lists of prior transactions associated with sending user 110, including prior transactions in which sending user 110 was in a receiving role. From the lists of prior transactions, other users involved in these transactions are identified. As disclosed above, this list of other users participating in transactions with sending user 110 may be referred to as the sender's group. Other information associated with sending user 110 and the users in the sender's group may be collected, such as the information disclosed above in regards to FIG. 6. Receiver information 122 may include similar information as sender information 112, but related to receiving user 120.

Method 700 includes determining, by the server computer system, a similarity value indicative of an amount of similarity between the sender information and the receiver information (block 730). Server computer system 101 compares sender information 112 and receiver information 122 to identify common and/or closely related details. For example, as shown in FIGS. 2-6, server computer system 101 identifies group links within each of the sender's group and the receiver's group, direct links between sending user 110 and receiving user 120, and indirect links between sending user 110 and receiving user 120 involving one or more counterparties. A fraud probability value, such as similarity value 107, is determined based on a number of identified links. In some embodiments, values representing each identified link may be weighted based on a type of link. For example, direct links may be weighted higher than indirect links. Additional information associated with the link, such as a direction of a prior transaction, may also be used to increase or decrease a weighting of a particular link.

Furthermore, method 700 includes assessing, by the server computer system based on the similarity value, whether the flagged transaction is valid (block 740). Based on the value of similarity value 107, server computer system 101 makes a determination whether flagged transaction 140 is valid or fraudulent. In some embodiments, a single threshold value may be used to make a valid or fraudulent determination. A similarity value 107 that reaches the threshold value may be regarded as fraudulent, and otherwise identified as valid. In other embodiments, several threshold values may be used as a scale indicating a probability that flagged transaction 140 is fraudulent. If similarity value 107 reaches a highest threshold value, then flagged transaction 140 is identified as fraudulent. If similarity value 107 fails to reach a lowest threshold value, then flagged transaction 140 is identified as valid. If similarity value 107 reaches any threshold less than the highest threshold value, then server computer system 101 may flag the claim associated with flagged transaction 140, and in some embodiments, additional information may be requested from sending user 110 and/or receiving user 120 in order to make a final determination of the validity of flagged transaction 140. The method ends in block 790.

It is noted that server computer system 101 determines a likelihood that sending user 110 and receiving user 120 are working together to defraud the operator of the transaction service. Method 700 may not make any determination whether receiving user 120 intended to defraud sending user 110. Server computer system 101 may identify flagged transaction 140 as valid if the similarity value indicates that sending user 110 acted in good faith when initiating flagged transaction 140. The intentions of receiving user 120 towards sending user 110 may not be considered when identifying flagged transaction 140 as valid.

It is further noted that method 700 includes operations 701-790. While these elements are shown in a particular order for ease of understanding, other orders may be used. In various embodiments, some of the method elements may be performed concurrently, in a different order than shown, or may be omitted. Additional method elements may also be performed as desired. For example, operations 720 and 730 may be performed in an iterative and/or overlapping manner in which a similarity value, or a portion thereof, is determined based on partially collected information while the collection of information continues.

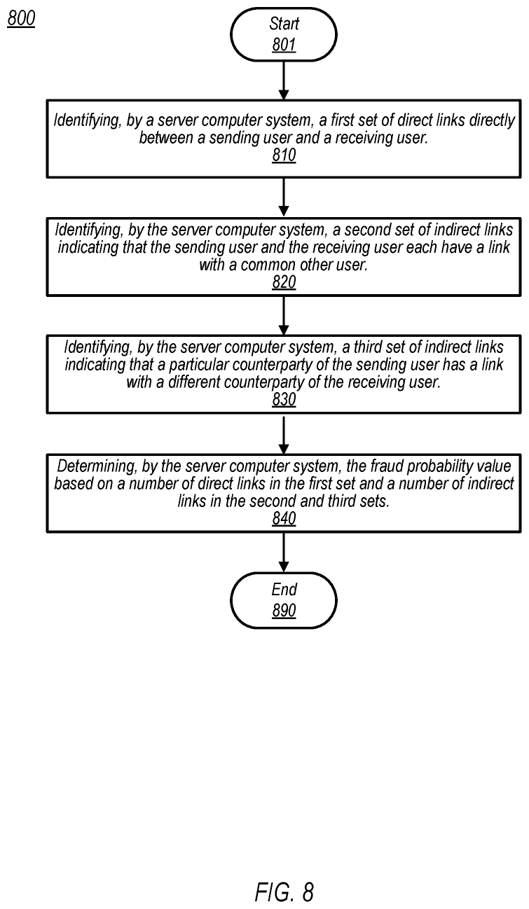

Proceeding now to FIG. 8, a flow diagram of an embodiment of a method for determining a fraud probability value by a server computer system is illustrated. Method 800 provides additional details describing how a fraud probability value may be determined using transaction information. In some embodiments, method 800 may represent operations that occur in block 730 of method 700 in FIG. 7. Accordingly, method 800 may be performed by server computer system 101 of FIG. 1 to determine a fraud probability value for flagged transaction 140. Referring collectively to FIGS. 1 and 8, method 800 begins in block 801 after transaction information has been collected for sending and receiving users associated with a flagged transaction on a transaction service.

Method 800 includes identifying, by a server computer system, a first set of direct links directly between a sending user and a receiving user (block 810). As illustrated in FIG. 3, direct links include information that is common to sending user 110 and receiving user 120. The type of information used for a link includes a prior transaction, such as prior transaction 341 and a device identification value, such as device ID 201. Additional types of information may be used for determining links, such as networking information associated with accessing the transaction service, contact information included in a user's account, financial information associated with a user, and the like. A direct link occur when a particular piece of information is common to both sending user 110 and receiving user 120 with no other user interposed. The first set of direct links may include all direct links that server computer system 101 identifies between sending user 110 and receiving user 120.

Furthermore, method 800 includes identifying, by the server computer system, a second set of indirect links indicating that the sending user and the receiving user each have a link with a common other user (block 820). Referring to FIG. 4, a second set of links includes indirect links that include an intermediate user that is common to both sending user 110 and receiving user 120. A first type of indirect link may occur when a particular piece of information is common to both sending user 110 and a member of the receiver's group, excluding receiving user 120. This first type of indirect link may also occur when a particular piece of information is common to both receiving user 120 and a member of the sender's group, excluding sending user 110. The second set of indirect links may include all of the first type of indirect links that server computer system 101 identifies between sending user 110 and members of the receiver's group, and vice versa.

Method 800 also includes identifying, by the server computer system, a third set of indirect links indicating that a particular counterparty of the sending user has a link with a different counterparty of the receiving user (block 830). As illustrated by FIG. 5, a second type of indirect link includes links between a member of the sender's group and a member of the receiver's group, in which neither sending user 110 nor receiving user 120 are directly associated with the link. The third set of indirect links may include all of the second type of indirect links that server computer system 101 identifies between members of the sender's group and members of the receiver's group.

In addition, method 800 includes determining, by the server computer system, the fraud probability value based on a number of direct links in the first set and a number of indirect links in the second and third sets (block 840). Server computer system 101 uses the first, second, and third sets of identified links to determine a fraud probability value, such as similarity value 107. Various methods may be used to determine the fraud probability value, such as adding together all identified links in the three sets, or determining a weighted value for each set and then adding the weighted values together. In some embodiments, look up tables may be employed to generate the fraud probability value based on the respective numbers of identified links in each of the three sets. Once a fraud probability value has been determined, the method ends in block 890.

It is noted that method 800 is merely an example. Operation 801-890 are illustrated as occurring in sequential order. In other embodiments, however, some operations may overlap. For example, operations 810, 820, and 830, may occur in parallel, with each set of links being incremented as a new link is detected. In some embodiments, some operations may be added or omitted. A different operation, for example, identifying a fourth set of links corresponding to group links (as described in regards to FIG. 2) may be included when determining the fraud probability value.

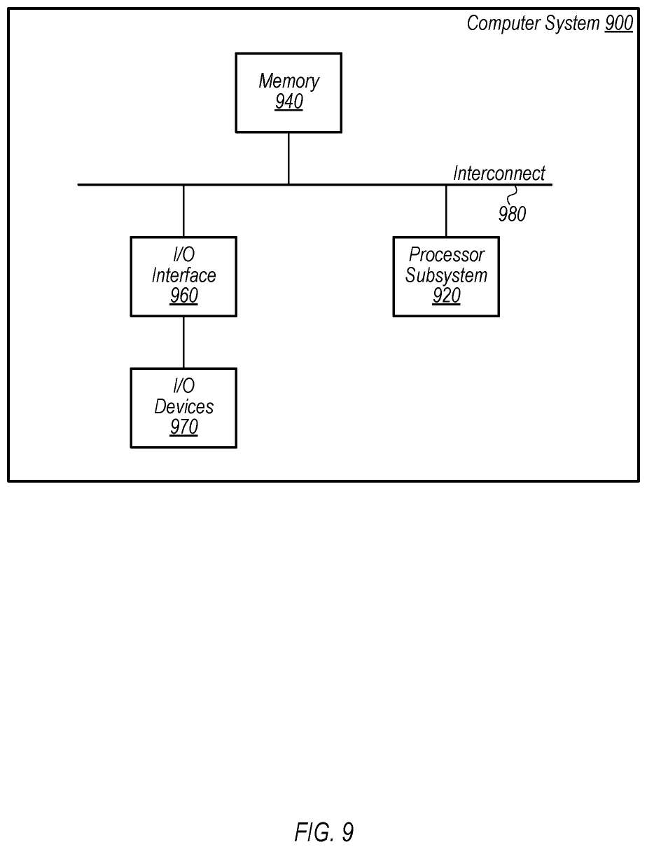

Referring now to FIG. 9, a block diagram of an example computer system 900 is depicted, which may implement one or more computer systems, such as server computer system 101 of FIG. 1, according to various embodiments. Computer system 900 includes a processor subsystem 920 that is coupled to a system memory 940 and input/output (I/O) interfaces(s) 960 via an interconnect 980 (e.g., a system bus). I/O interface(s) 960 is coupled to one or more I/O devices 970. Computer system 900 may be any of various types of devices, including, but not limited to, a server computer system, personal computer system, desktop computer, laptop or notebook computer, mainframe computer system, server computer system operating in a datacenter facility, tablet computer, handheld computer, workstation, network computer, etc. Although a single computer system 900 is shown in FIG. 9 for convenience, computer system 900 may also be implemented as two or more computer systems operating together.

Processor subsystem 920 may include one or more processors or processing units. In various embodiments of computer system 900, multiple instances of processor subsystem 920 may be coupled to interconnect 980. In various embodiments, processor subsystem 920 (or each processor unit within 920) may contain a cache or other form of on-board memory.

System memory 940 is usable to store program instructions executable by processor subsystem 920 to cause computer system 900 perform various operations described herein. System memory 940 may be implemented using different physical, non-transitory memory media, such as hard disk storage, floppy disk storage, removable disk storage, flash memory, random access memory (RAM—SRAM, EDO RAM, SDRAM, DDR SDRAM, RAMBUS RAM, etc.), read only memory (PROM, EEPROM, etc.), and so on. Memory in computer system 900 is not limited to primary storage such as system memory 940. Rather, computer system 900 may also include other forms of storage such as cache memory in processor subsystem 920 and secondary storage on I/O devices 970 (e.g., a hard drive, storage array, etc.). In some embodiments, these other forms of storage may also store program instructions executable by processor subsystem 920.

In addition, transaction information 103 in FIG. 1 may be stored in system memory 940. For example, transaction information 103 may be stored in a system RAM within system memory 940 while server computer system 101 performs operations described herein. Transaction information 103 may also be stored in a non-volatile memory, such as a hard drive or solid-state drive included in I/O devices 970.

I/O interfaces 960 may be any of various types of interfaces configured to couple to and communicate with other devices, according to various embodiments. In one embodiment, I/O interface 960 is a bridge chip (e.g., Southbridge) from a front-side to one or more back-side buses. I/O interfaces 960 may be coupled to one or more I/O devices 970 via one or more corresponding buses or other interfaces. Examples of I/O devices 970 include storage devices (hard drive, optical drive, removable flash drive, storage array, SAN, or their associated controller), network interface devices (e.g., to a local or wide-area network), or other devices (e.g., graphics, user interface devices, etc.). In one embodiment, I/O devices 970 includes a network interface device (e.g., configured to communicate over WiFi, Bluetooth, Ethernet, etc.), and computer system 900 is coupled to a network via the network interface device.

Although the embodiments disclosed herein are susceptible to various modifications and alternative forms, specific embodiments are shown by way of example in the figures and are described herein in detail. It should be understood, however, that figures and detailed description thereto are not intended to limit the scope of the claims to the particular forms disclosed. Instead, this application is intended to cover all modifications, equivalents and alternatives falling within the spirit and scope of the disclosure of the present application as defined by the appended claims. The headings used herein are for organizational purposes only and are not meant to be used to limit the scope of the description.

This disclosure includes references to “one embodiment,” “a particular embodiment,” “some embodiments,” “various embodiments,” “an embodiment,” etc. The appearances of these or similar phrases do not necessarily refer to the same embodiment. Particular features, structures, or characteristics may be combined in any suitable manner consistent with this disclosure.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. As used herein, the term “or” is used as an inclusive or and not as an exclusive or. For example, the phrase “at least one of x, y, or z” means any one of x, y, and z, as well as any combination thereof (e.g., x and y, but not z).

It is to be understood that the present disclosure is not limited to particular devices or methods, which may, of course, vary. It is also to be understood that the terminology used herein is for the purpose of describing particular embodiments only and is not intended to be limiting. As used herein, the singular forms “a,” “an,” and “the” include singular and plural referents unless the context clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

Within this disclosure, different entities (which may variously be referred to as “units,” “circuits,” other components, etc.) may be described or claimed as “configured” to perform one or more tasks or operations. This formulation—[entity] configured to [perform one or more tasks]— is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “memory device configured to store data” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Should Applicant wish to invoke Section 112(f) during prosecution, it will recite claim elements using the “means for” [performing a function] construct.

In this disclosure, various “modules” operable to perform designated functions are shown in the figures and described in detail above. As used herein, the term “module” refers to circuitry configured to perform specified operations or to physical, non-transitory computer-readable media that stores information (e.g., program instructions) that instructs other circuitry (e.g., a processor) to perform specified operations. Such circuitry may be implemented in multiple ways, including as a hardwired circuit or as a memory having program instructions stored therein that are executable by one or more processors to perform the operations. The hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority hereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
receiving, by a server computer system, an indication of a flagged transaction between a sending user and a receiving user of a transaction service;
collecting, by the server computer system responsive to the indication, transaction information including:
sender information indicative of previous transactions within the transaction service involving the sending user, including transactions with users other than the receiving user; and
receiver information indicative of previous transactions within the transaction service involving the receiving user, including transactions with users other than the sending user;
determining, by the server computer system, a similarity value indicative of an amount of similarity between the sender information and the receiver information; and
assessing, by the server computer system based on the similarity value, whether the flagged transaction is valid.

2. The method of claim 1,
wherein the determining the similarity value is based on identified links between the sending user and the receiving user, wherein the identified links include:
a first set of direct links between the sending user and the receiving user;
a second set of indirect links indicating that the sending user and the receiving user each have a link with a common other user; and
a third set of indirect links indicating that a first counterparty of the sending user has a link with a second counterparty of the receiving user.

3. The method of claim 2, wherein links include contact information for each user.

4. The method of claim 2, wherein the first set of direct links includes prior transactions between the sending user and the receiving user, and wherein ones of the prior transactions in which the sending user was a receiver and the receiving user was a sender are weighted higher than other ones of the prior transactions.

5. The method of claim 1, further comprising:
identifying, using the sender information, a sender group that includes other users with whom the sending user has conducted transactions within the transaction service;
identifying, using the receiver information, a receiver group that includes other users with whom the receiving user has conducted transactions within the transaction service; and
wherein determining the similarity value includes determining similarities between the sender group and the receiver group.

6. The method of claim 1, wherein determining the similarity value includes determining an amount of data added by the sending user and an amount of data added by the receiving user to their respective accounts with the transaction service within a specified period of time.

7. The method of claim 1, wherein determining the similarity value includes determining a number of direct and indirect links between the sending user and the receiving user, wherein direct links are weighted more heavily than indirect links in determining the similarity value.

8. A non-transitory, computer-readable medium storing instructions that, when executed by a server computer system of a transaction service, cause the server computer system to perform operations comprising:
in response to an indication of a flagged transaction, reviewing transaction history that includes:
sender history corresponding to transactions associated with a sending user of the flagged transaction; and
receiver history corresponding to transactions associated with a receiving user of the flagged transaction; and
determining a fraud probability value based on a number of links between the sender history and the receiver history, wherein the fraud probability value indicates a likelihood of fraud involving the sending user and the receiving user.

9. The computer-readable medium of claim 8, wherein determining the fraud probability value includes identifying links between the sending user and the receiving user, wherein the identified links include:
a first set of direct links between the sending user and the receiving user;
a second set of indirect links indicating that the sending user and the receiving user each have a link with a common other user; and
a third set of indirect links indicating that a particular counterparty of the sending user has a link with a different counterparty of the receiving user.

10. The computer-readable medium of claim 9, wherein operations further comprise determining the fraud probability value based on a number of direct links in the first set and a number of indirect links in the second and third sets.

11. The computer-readable medium of claim 9, wherein determining the fraud probability value further includes:
identifying a fourth set of links between two or more counterparties of the sending user; and
identifying a fifth set of links between two or more counterparties of the receiving user.

12. The computer-readable medium of claim 9, wherein links include global positioning system (GPS) information for each user, wherein the GPS information indicates a location of a respective user when the respective user is logged into the transaction service.

13. The computer-readable medium of claim 8, wherein determining the fraud probability value includes determining a number of previously flagged transactions associated with the sending user and a number of previously flagged transactions associated with the receiving user.

14. The computer-readable medium of claim 8, wherein the operations further comprise assessing that the flagged transaction is valid in response to determining that the fraud probability value does not reach a threshold fraud value.

15. A system comprising:
a memory storing instructions; and
a processor configured to execute the instructions to cause the system to:
receive an indication of a flagged transaction between a sending user and a receiving user of a transaction service;
in response to the indication, retrieve from a history of transactions:
sender history corresponding to transactions associated with the sending user; and
receiver history corresponding to transactions associated with a receiving user of the flagged transaction;
generate a fraud probability value based on a number of links between the sender history and the receiver history; and
determine whether the flagged transaction is valid based on the fraud probability value.

16. The system of claim 15, wherein to generate the fraud probability value, the processor is configured to execute instructions to identify direct and indirect links between the sending user and the receiving user.

17. The system of claim 16, wherein the processor is further configured to execute instructions to determine the fraud probability value using the number of the direct links and the number of the indirect links.

18. The system of claim 17, wherein the indirect links include:
one or more links between the sending user, the receiving user, and one or more common other users; and
one or more links between counterparties of the sending user and counterparties of the receiving user.

19. The system of claim 16, wherein to generate the fraud probability value, the processor is configured to execute instructions to determine a number of previously flagged transactions associated with the sending user and a number of previously flagged transactions associated with the receiving user.

20. The system of claim 19, wherein the processor is configured to execute instructions to use the number of previously flagged instructions associated with the sending and receiving users, a number of direct links, and a number of indirect links to generate the fraud probability value, wherein direct links are weighted more heavily than indirect links in determining the fraud probability value.
